(19) United States
(12) Patent Application Publication
(10) Pub. No.: US 2002/0166819 A1
(43) Pub. Date: Nov. 14, 2002

(54) System and method for separating components of liquid manure

(75) Inventors: Camil Dutil, St-Augustin-de-Desmaures (CA); Gilles Gagne, Quebec (CA); Rock Chabot, St-Lambert-de-Lauzon (CA); Yves Comeau, Laval (CA)

Correspondence Address: OGILVY RENAULT, 1981 MCGILL COLLEGE AVENUE, SUITE 1600, MONTREAL, QC, H3A2Y3, CA

(73) Assignee: ENVIROGAIN INC., St-Romuald (CA)

(21) Appl. No.: 10/120,776

(22) Filed: Apr. 12, 2002

Related U.S. Application Data
(60) Provisional application No. 60/283,149, filed on Apr. 12, 2001.

(51) Int. Cl. C02F 1/00

(52) U.S. Cl. 210/696; 210/723; 210/631

(57) ABSTRACT

The present invention relates to a system and method for the treatment of liquid manure and wastewater produced in animal production plans. The method combined application of filtration, bioreaction, and electrochemical treatment to effect separation of contaminants from the water fraction.

### BACKGROUND OF THE INVENTION

(a) Field of the Invention

The present invention generally relates to a method of treatment of aqueous wastes rich in organic content, either soluble or particulate, and is more specifically concerned by purifying water from industrial or animal waste such as liquid animal waste, leachate from landfill sites or waste water from food processing industry. The invention relates to the removal of contaminants from an aqueous medium. More particularly, the invention relates to a method involving the combination of filtration, an electrochemical process, namely electroflotation, for agglomerating phosphorus contaminants. These phosphorus contaminants once agglomerated (flocks), float at the surface of the aqueous medium and can therefore be separated therefrom. The present invention relates to a process for the purification of a medium containing organic waste.

It also relates to the application of the process to the treatment of organic dejecta, in particular liquid animal manure, especially liquid pig manure.

(b) Description of Prior Art

In many countries, aqueous waste management, domestic, industrial or agricultural, has been and is still carried out without much concern for the environment. However, septic tank sludge, animal waste such as liquid waste found on an animal production plan or a farm, leachate from landfill sites or wastewater from food processing industry have been the target of restrictions and protective measures to reduce the impact of their disposal into the environment. Some solutions have been applied to solve some of the problems associated with these human activities. In some cases, however, the lack of an acceptable solution has hampered or halted the growth of some industries. The best example is the pig industry, which has brought many producing countries into investing significant sums of money into research and development of technologies for treating animal waste. In conventional fattening animal production plan, the raw slurry containing animal urine and feces is usually collected and stored in ponds or large concrete structures where it is allowed to decompose freely until it is used as fertilizer. Odor production and emissions are left uncontrolled, fertilizer quality is highly variable and/or potentially lost to the atmosphere, and the volumes are diluted by precipitation. Furthermore, management of the fertilizer through intensive farming techniques brings a lot of environmental concern with respect to pollution when it is disposed of onto land (soil compaction, excess land spreading dosages, surface water runoff, groundwater contamination).

Besides the measures proposed for pollution source reduction, such as pig-on-litter systems, better nutrient assimilation through enzyme complement to the animal diet, volume reduction through better water management in the piggeries, different strategies for odor control and several types of physical-chemical treatment processes for liquid piggery waste have been studied. These include oligolysis, or electrolytic treatment (Ranalli et al., 1996, J. Env. Sci. Health A., 31:1705-1721), thermal dewatering technologies (Sirven process) or phase separation using membranes, chemical precipitation, centrifuges or other devices. Such technologies either propose only a partial treatment or require major capital investment.

Biological processes for treating liquid piggery waste have also been developed. For example, pig slurry treatment has been approached using aerobic or anaerobic technologies or a combination thereof. Potential applications for these technologies have been looked at either as regional facilities in areas where the pig industry is concentrated or as local facilities installed at the production site.

Also, the prior art contains a variety of different processes wherein direct current, or direct current having alternating currents superimposed thereon, is utilized to agglomerate solids suspended in aqueous liquid. U.S. Pat. No. 3,767,046 to Hartkorn is exemplary thereof

These prior processes incorporate many disadvantages, which tend to render them either economically unfeasible or very expensive to operate. For example, prior direct current agglomeration processes are characterized by a rapid deterioration of the anode and/or scaling or fouling thereof with organic materials from the solution, impurities from the metal itself, or impurities resulting from grain reactions at the anode surface. Therefore, a batch operation is required due to the necessity for frequent shut down to clean or replaces the anode, and continuous operation, or operation for extended periods of time is impossible.

Different cell additive materials may be used for reducing the tendency of the electrodes to scale, to improve current efficiency, and to prolong electrode life. These additives are effective in varying degrees. However, the expense involved in utilizing additives is substantial and is a definite disadvantage in direct current operation. Furthermore, as obvious to those skilled in the art, continuous operation or at least semi-continuous operation over a prolonged period of time without the need to shut down to replace or clean the anode is preferable from an economic standpoint to batch operation even with additives.

A method for agglomerating suspended solids in an aqueous solution exists. The method is characterized by the efficient use of alternating current, alone, to provide continuous operation without the necessity to frequently replace or descale the anode. Alternating current has been found to exert an electrostrictive effect on the suspended materials. In addition, alternating current continuously produces hydrogen peroxide at both electrodes, which tends to maintain the electrodes in clean condition during operation Finally, the hydrogen produced on the electrode has the capability of reacting with the electrode itself to produce, ultimately, minimal quantities of metal hydroxides that act as flocculation seeds to promote flocculation or agglomeration of the solid impurities. The electrostrictive effect and the production of hydrogen peroxide at each electrode are not possible in a direct current cell without the presence of sulfate radicals or other additives. Accordingly, the process is characterized by much more efficient operation in a continuous mode, without the necessity of using costly additive.

All the method and apparatus existing in the art at the moment do not enable to eliminate undesirable compounds enough to allow recovery of a water that can be returned in nature or in a production plan, as industrial or animal production plan without interfering with the different operation in the plans.

It would be highly desirable to be provided with an environmentally sound apparatus and a method of treating aqueous wastes rich in organic or industrial content, such as liquid animal waste remains.

### SUMMARY OF THE INVENTION

One object of the present invention is to provide a method for treating aqueous waste and wastewater for purifying and recovering water.

Another object of the present invention is to provide a method for treating animal rejection on an animal production plan to separate the solid matter from manure, for example but not limited to, and to reuse the purified water in the production plan.

In accordance with the present invention there is provided a method for treating aqueous waste containing undesirable material in solution comprising the steps of:

a) passing the aqueous waste through a filter to separate solid matter from liquid phase;

b) passing the filtered liquid phase of step a) through a bioreactor to obtain cleared liquid; and

c) passing the cleared liquid of step b) through an electrochemical system to obtain purified water.

The undesirable material may be selected from the group consisting of toxin, heavy metal, fluoride, hydrocarbon, oil, organic matter, and phosphorous products.

Also, in accordance with the present invention, there is provided a method for treating aqueous waste in an animal production plan containing undesirable materials in solution comprising the steps of:

a) passing the aqueous waste through a filter to separate the solid matter from liquid phase;

b) passing the liquid phase of step a) through a bioreactor to obtain cleared liquid;

c) passing the cleared liquid of step b) through an electrochemical system to obtain purified water; and returning the purified water to nature or recirculating at least a part of the purified water in the animal production plan.

The aqueous waste may also be selected from the group consisting of manure, dung, munk, used water, washing water, excrement, faeces, urine, and mixtures thereof.

The animal may be selected from the group consisting of porcine, equine, ovine, caprine, canine, feline, and bird.

The filter may be a membrane filter, porous hard wall, cloth drum type, or tangential filtration.

The bioreactor may be an aerobic bioreactor for treating the liquid phase comprising:

a reservoir having lower and upper portions, and opposite inflow and outflow ends;

an inlet located at the inflow end for supplying the liquid phase into the reservoir and an outlet located at the outflow end for supplying the liquid phase out of the reservoir;

at least one oxygen diffuser positioned in the lower portion of the reservoir for diffusing the oxygen or air in the liquid phase in the reservoir; and

a conduit system positioned in the upper portion of the reservoir for receiving the liquid phase having been treated in the bioreactor to give clear liquid, and discharging the clear liquid in a conduit system positioned at the outflow end.

The oxygen diffuser may be an air diffuser.

The electrochemical system used for removing contaminants from the cleared liquid may comprise:

at least one conduit for collecting the clear liquid containing contaminants in a frustro-conical container, the frustro-conical container comprising a lower inlet opening for the supply of the clear liquid into the frustro-conical container, an upper outlet opening underflow line for the outlet of an electroflocculated clear liquid to give purified water, an upper outlet opening overflow line for rejection of the contaminant rendered floating by electroflocculation;

at least one frustro-conical container in fluid flow connection with the conduit for receiving therein the clear liquid, the container having a plurality of substantially parallel electrolytic plates contained therein, the electrolytic plates having a plurality of positive and negative plates; and

a voltage source connected to the positive and negative plates for applying a differential electric potential therebetween, the differential electric potential causing the contaminants to react with the electrolytic plates to flocculate and induce floating of the contaminants, the contaminants rendered floating being separated from the clear liquid to yield purified water, the contaminants rendered floating being separated from the clear liquid at an overflow outlet trap, the floating contaminants falling into the trap, and the purified water being removed through the upper outlet opening underflow line.

At least one flocculating agent may be added in the cleared liquid during the voltage application to precipitate phosphorus and nitrogen compounds. The flocculating agent may be selected from the group of metal particle, cationic product, anionic compound, iron salt, aluminum salt, magnesium salt, ferrous chloride, ferrous sulfate, ferric chloride, ferric sulfate, chlorinated ferric sulfate, basic aluminum sulfate, chlorinated basic aluminum sulfate, magnesium chloride, and magnesium sulfate.

After filtration, the liquid phase may be composed of about 70 to 99 percent of water.

Also, the solid mater obtained after filtering the aqueous waste, may be recovered under the form of fertilizer or ground additive.

Another object of the invention is to provide a liquid manure treatment system comprising at least one of a separation system for separating liquid phase and solid phase of liquid manure or a bioreactor for clarifying separated liquid phase by aeration to obtain clarified aqueous phase, in combination with an electrochemical system inducing at least one of a flocculation, coagulation or disinfection of particles contained into the clarified aqueous phase.

The separation system may perform at least one of sifting, riddling, filtration, settling, sedimentation, or pressing.

The liquid manure treatment system may also comprise a draining system continuously or periodically evacuating the liquid manure from an animal production farm and displacing the liquid manure to the separation system.

The electrochemical system can comprise a water streaming filter.

The separation may also be performed with a filter which is a membrane filter, porous hard wall, cloth drum type, or tangential filter.

The liquid manure treatment system can comprise a derived filter system using fibres obtained from dehydrated solid phase of manure for filtering at least a portion of the clarified aqueous phase before or after treatment by the electrochemical system.

The system can alternatively comprise a filter after the separation system or the bioreactor for filtering the clarified aqueous phase to allow elimination of gas from the clarified aqueous phase. The filter can a bioreactor, a liquid trickling system or a combination thereof.

The elimination of gas can be preformed by at least one of degradation by micro-organisms or solubilization in the clarified aqueous phase.

Another object of the invention is to provide a method for separating liquid phase and solid phase from liquid manure comprising the steps of:

a) passing liquid manure through at least one of a separation system to separate solid phase from liquid phase or through a bioreactor to obtain a clarified aqueous phase; and

b) passing the clarified aqueous phase of step a) through an electrochemical system for inducing flocculation of particles in the clarified aqueous phase of step a) and to obtain purified and disinfected water.

The purified and disinfected water can be returned to nature or recycling at least a part in an animal production plan or liquid manure treatment system.

The method can be applied and the system used on an animal production plan is for production of farm animals for production of porcine, bovine, equine, ovine, caprine, or bird.

The solid phase can be recovered as a fertilizer or a ground additive.

The electrochemical system used in the system and method of the present invention for removing contaminants from clarified aqueous phase can comprise:

at least one conduit for collecting the clarified aqueous phase containing contaminants;

at least one electrochemical cell comprising a container in fluid flow connection with the conduit for receiving therein the clarified aqueous phase, the container having at least two substantially parallel electrolytic plates contained therein, the electrolytic plates having a plurality of positive and negative plates, the frustro-conical container comprising an upper outlet underflow line opening for the outlet of purified water, and an upper outlet overflow line opening for rejection of the contaminants; and

a voltage source connected to the positive and negative plates for applying a difference potential there between, the difference potential causing the contaminants in reaction with the electrolytic plates to flocculate and to float, the contaminants being separated from the clarified aqueous phase to provide purified and disinfected water, the contaminants rendered floating being separated from the clarified aqueous phase at an overflow outlet trap, the contaminants falling into the trap, and the purified and disinfected water being removed through the upper outlet opening underflow line.

In one aspect of the invention at least one flocculating agent can be added to the separation system or electrochemical system with the liquid manure to precipitate phosphorus and nitrogen compounds. The flocculating agent can be selected from the group of metal particle, cationic compound, anionic compound, iron salt, aluminum salt, magnesium salt, ferrous chloride, ferrous sulfate, ferric chloride, ferric sulfate, chlorinated ferric sulfate, basic aluminum sulfate, chlorinated basic aluminum sulfate, magnesium chloride, and magnesium sulfate.

The fibres obtained from dehydrated solid phase of manure can be additionally used to form a derived filter for filtering at least a portion of the clarified aqueous phase before or after treatment with the electrochemical system.

For the purpose of the present invention the following terms are defined below.

The terms “COD” and “BOD”, as well-known in the art, relate to the chemical oxygen demand and biochemical oxygen demand, respectively. The COD is a chemical oxidation method for the measure of all the matter, which is chemically oxidizable. It is always higher than the carbonaceous BOD because it includes both bio- and non-biodegradable matters. The carbonaceous BOD represents the quantity of oxygen used by bacteria to oxidize the biodegradable matter present in a sample of aqueous waste in a period of, normally, five days.

As used herein, the designation “organic wastes” is meant to cover preferably organic wastes having high organic content. Non-limiting examples of such organic wastes include animal slurries such as liquid piggery waste, septic tank sludge, landfill site leachate and agro-food or other industrial wastewater. Preferably, the organic loading of the bioreactor will be about 0.17 to 0.46 LB total COD/ft3.d or about 0.06 to 0.17 LB filtered COD/ft3A It shall be understood that the organic content of the aqueous wastes which can be efficiently treated in accordance with the present invention depends on the concentration of volatile suspended solids (VSS) or biocatalyst in the bioreactor. For example, an increase in the concentration of VSS should allow the treatment of aqueous wastes having higher organic concentration. It follows that the concentration of VSS can be adapted as a function of the organic content of the aqueous waste.

The term “biodegradation” denotes the fact that a biological catalyst that is freely suspended and develops from the facultative aerobic microbial flora present in the waste to be treated enables the treatment or degradation of the organic waste in the bioreactor. Of course, it will be understood that the biological catalyst can be added to the waste to be treated and that the microbial flora to be added can be adapted to the type of pollutant to be removed from the aqueous waste. In addition, inoculation of the bioreactor will often take place naturally by the microbial flora contained in the aqueous waste. It shall also be understood that a particular type of aqueous waste generally contains a microbial flora that is usually best adapted to the degradation of the substrate in which it lives. The bioreactor of the present invention and method of degradation using same, favor and select for the development of such a microbial flora, thereby enabling an efficient and complete biodegradation of the organic content, provided that an adequate sludge retention time is applied. The microbial flora refers generally to bacteria and higher life forms such as protozoa that develop in the mixed liquor. The bioreactor also enables the production of flocs. Thus, the present bioreactor and method of using same are adaptable to the treatment of different types of aqueous wastes at high organic content, provided that the microbial flora has the necessary growth conditions inside the bioreactor. The adequate sludge retention time can be determined by the person of ordinary skill as a function of the food mass ratio (F/M) of the F/M inside the bioreactor, of the hydraulic retention time and of the level of purification performance of the bioreactor, which is targeted.

As used herein the term “flocs”, well-known to a person of ordinary skill to which the present invention pertains, refers to a flocculent mass formed by the aggregation of inert and biologically active particles. The present invention enables the production of flocs without a dependence upon added flocculating agents. Under certain conditions, the addition of flocculating agents although less preferred (see below) could also be envisaged.

As used herein, “sludge or biological sludge” is well-known in the art and denotes that the sludge is of biological origin and that it provides a biomass. Non-limiting examples of sludge thickening include, centrifugation, drainage on porous bed, filtration on membrane or by press. Non-limiting examples of sludge stabilization include composting, lime treatment, and aerobic or anaerobic digestion. Sludge disposal usually pertains to disposal in a landfill site unless sludge land farming is possible and/or permitted. Thermal destruction of sludge is yet another method to dispose of the sludge.

The recitation “organic loading” can be expressed as a function of the volume of the reactor or as a function of the concentration of biocatalyst in the bioreactor. It is usually expressed as unit mass of COD or BOD per unit volume of reactor per day (lb COD or BOD/ft′.d) or as a unit mass of COD or BOD per unit mass of biocatalyst per day (lb COD or BOD/lb VSS.d).

Depending on the sludge retention time and on the hydraulic retention time, the bioreactor and method of the present invention enable a reduction of total COD of the influent waste in excess of 90% after the clarification step. The reduction can be as high as about 98%. Thus, the bioreactor of the present invention and the method of treating aqueous waste of high organic content of the present invention provide a very efficient reduction in organic content of such aqueous wastes.

In this context, aqueous wastes having a carbonaceous BOD between about 100 to about 100,000 mg BODS/L, preferably 3,000 to 30,000 mg BOD-L, and defining an example of aqueous wastes having high organic content, are encompassed as being within the scope of the present invention. As a reference, domestic wastewater has organic contents between 100-400 mg BODdL and typically about 250 mg BODdL. Using the bioreactor of the present invention to treat such a type of aqueous waste would require an increase in the sludge retention time in order to obtain the optimal F/M for the targeted purification performance. As used herein the BOD values are pertinent to indicate the type of aqueous wastes that are within the scope of the present invention. It should not be used to characterize the size of the treatment units, however. In this context, the size of the unit should be based on the volumetric loading to the reactor (i.e. unit mass of COD or BOD per m′ of reactor volume per day).

The recitation “freely suspended microbial flora” refers to the biomass being in a suspended growth process as opposed to the biomass being in an attached growth process.

The recitation “aqueous organic waste” refers to the fact that the solvent is water as opposed to oil or the like.

The bioreactor and the method of the present invention provide the significant and novel advantage of enabling the treatment of influents containing suspended solids in concentrations as high as 6.5%. The bioreactor and the method of the present invention maintain thorough mixing conditions and thereby the homogeneity of the suspended solids in the reactor.

The biocatalyst, as characterized by the content of volatile suspended solids, is generally present in the aqueous wastes and contributes to the concentration of suspended solids. The bioreactor and the method of the present invention allow the treatment of aqueous wastes containing concentrations of VSS in the range of 0 to 50,000 mg/L, preferably in the range of 10,000 to 30,000 mg/L.

With the present object, the invention proposes to provide a process for the purification of a medium (or effluent) containing organic waste, in which the medium is subjected to a combination of specific chemical, physical or physicochemical treatments, all the organic waste contained in this medium being treated and, preferably, no unrecovered waste remaining on conclusion of the process, which process is simple and economic to implement.

Moreover, the discharge to the natural environment (water courses, irrigation, and the like) of the aqueous part of the effluents treated according to the invention becomes possible because it is advantageously odorless, clear, sterile and relatively depleted in BOD and COD

Finally, the process according to the present invention makes it possible, in particular in the case of the treatment of liquid animal manures (in particular liquid pig manure), to obtain sludge which can be spread directly, that is to say which can be used directly as agricultural fertilizer without it being necessary to add fertilizing adjuvants thereto.

Thus, another object of the invention is a process for the purification of a medium containing organic waste, characterized in that it comprises an oxidation treatment (in particular of chemical type), a flocculation treatment, a treatment using a polyelectrolyte (in particular of the anionic or cationic type), a filtration and, preferably, an ultrafiltration.

Another object of the invention consists in the application of the process in purifying media (or effluents) containing organic dejecta, in particular organic dejecta of human origin, or liquid animal manures, in particular from animals of bovine, ovine or porcine type or from poultry.

### BRIEF DESCRIPTION OF THE DRAWINGS

FIG. 1 shows a schematic representation of an electrochemical system that may be used in the method according to one embodiment of the present invention.

### DETAILED DESCRIPTION OF THE INVENTION

In accordance with one embodiment of the present invention, there is provided a method of treating aqueous waste products, or wastewater coming from different animal production plans, or industrial systems.

In one embodiment of the present invention, there is provided a method of purifying water comprising a first step of filtering aqueous waste in order to significantly separate the solid matter from the liquid phase, that is to say water. The remaining filtered liquid phase may be composed of between about 50 to 100 percent of water, but preferably of 70 to 99 percent of water.

In another embodiment of the invention, the filtration step may be performed in different manners, by using for example, but not limited to, soft or hard porous membranes.

In another embodiment of the invention, there is provided a system and method for globally treating liquid manure from a container or directly from an animal production plan. The parts and steps of the system and method are, for example but not limited to, transferring continuously or intermittently the liquid manure from an animal production plan provided with a washing system with controlled water flow, allowing therefore a first step of managing evacuation of the liquid manure and odors from the production plan. After that, the liquid manure is treated to perform the separation of the liquid and the solid phases of the liquid manure

Alternatively, filtration may be carried out with membrane filter, porous hard wall, cloth drum type, or by tangential filtration.

In one particular embodiment of the invention, the solid matter obtained following filtration may be recovered and reused as fertilizer matter or mixed to any ground enrichment products in agriculture and in different specific vegetable production plan.

According to one embodiment of the present invention there is provides a well-mixed flow aerobic bioreactor of compact size wherein agitation and aeration are supplied by an air lift pump and air diffusers and which is adapted for the treatment of aqueous wastes at high organic loading and methods of use thereof.

In one embodiment, the present invention provides a bioreactor wherein agitation and aeration are supplied by at least one air lift pump, and at least one diffuser, which can maintain homogeneity of inert and biological suspended solids at concentrations of at least 2 to 10 times (1% to 5% mixed liquor suspended solids) that of conventional municipal wastewater treatment systems. Indeed, in most activated sludge processes, reactor solids concentration is in the range of 2.000-7,000 mg SS/L. The present invention provides the means to handle reactor solids concentrations of about 24,000 mg SS/L (from 3,000-53.000 mg SS/L). It will be appreciated by a person of ordinary skill that pure oxygen can enable a handling of reactor solids of even higher concentrations. It should also be recognized that the type and concentration of specific gases (nitrogen, ammonia, etc.) introduced into the bioreactor can be adapted, by the person of ordinary skill, to meet specific needs of the substrate to be treated and/or of the level of performance of purification to be achieved.

In still another embodiment of the present invention, there is provided a bioreactor, wherein raw aqueous wastes containing grains, sand particles, animal hair and other small debris, can be handled without plugging, thereby overcoming or reducing the need for a separation of the suspended solids from the aqueous waste as in necessary in the systems of the prior art.

In another embodiment of the invention there is provided an control over the shear stress imposed on a biological catalyst to insure swift and proper separation of the biological solids from the liquid effluent by passive settling. The instant invention provides the means to minimize foam formation and wherein excess foam can be controlled chemically by vegetable oil, animal fat and the like and/or mechanically (i.e. commonly known foam breakers). It will be understood that foam problems are linked to the substrate or aqueous waste, which is treated. In the case of piggery waste with which foam problems can be encountered, minimizing foam formation is important. It will be recognized that foam problems are generally only encountered at the start up of the bioreactor. Once the bioreactor has been stabilized, foam control is usually not necessary.

Furthermore, the present invention provides a bioreactor wherein air may be supplied at low pressure and high flow-rate thus preventing ammonia stripping and allowing assimilation of ammonia nitrogen by the microbial flora.

The bioreactor of the present invention provides the means to release the oxygen-containing medium (such as air) into the tank of the bioreactor at a pressure which is slightly superior to the hydrostatic water pressure in the bioreactor at the site where the oxygen-containing medium is delivered (a function of the height of the mixed liquor column). By providing a relatively low air pressure, which minimizes or avoids a substantial migration of ammonia to the surface of the mixed liquor and eventually a degasing thereof of its ammonia (i.e. stripping of the ammonia) the bioreactor of the present invention allows a substantial assimilation of the ammonia by the flora.

In another embodiment, there is provided a bioreactor wherein flow patterns and mass transfer can be controlled in different sections of the bioreactor and wherein high dissolved and high rendered oxygen concentrations can be maintained at the bottom of the bioreactor. It will thus be recognized that the bioreactor of the present invention enables a modulation of the level recycling of the mixed liquor as well as of the level of residual oxygen at different levels or different sections within the bioreactor (i.e. by changing the flow rate within the air lift pump or modulating the flow rate of the air diffuser).

It is to be understood that the manure retention time will have to be adapted as a function of the specific type of treatment and aqueous waste treated. In certain situations, in which no manure recycling is used, the sludge retention time will be equal to the hydraulic retention time. However, in order to ensure an efficient clarification, there exists an optimal sludge retention time, which may be dependent on the type of aqueous waste and the hydraulic retention time. As mentioned above, this optimal sludge retention time can be determined by conventional means by the person of ordinary skill to which the present invention pertains.

In one preferred embodiment, the liquid manure is continuously or intermittently removed from an animal production plan or a container with a system using a control subsystem for washing water flow to manage the evacuation of manure and odors from the plan. The liquid manure is then treated for separating the liquid to the solid phase. Once separated from the solid phase, the aqueous phase submitted to aerobic or anaerobic in a bioreactor with agitation and oxygenation. Pollutants are therefore metabolized by microorganisms presents in the bioreactor. Following this biological treatment, the liquid phase is purified from gases and odors on a trickling system allowing aeration, metabolization by microorganisms and solubilization of different ammoniac and phosphorus. A clarified aqueous phase is then obtained. Minerals and other particles can be rescued for composting or in the preparation of ground additives or fertilizers. The clarified aqueous phase is then submitted to an electrochemical treatment which finalizes the purification and disinfection of the water in the aqueous fraction. The water obtained can be recycled in the animal production plan or simply returned in nature.

It shall also be understood also that the bioreactor tank of the present invention can be under or above the ground level or alternately at intermediate levels. The person of ordinary skill, will be able to adapt the system to the correct level.

According to one embodiment of the present invention, there is provided a method comprising a step of electrochemical treatment in conditions allowing to eliminate the requirement of frequent periodic replacement of the electrodes.

The electrochemical system of the method provides increased aluminum or metallic dissolution into a solution so that heavy suspensions and emulsions may be effectively treated.

Also in another embodiment of the present invention, the electrochemical step allows agglomerating solids in an aqueous medium which is low-maintenance, efficient, rugged, easy to use, and inexpensive.

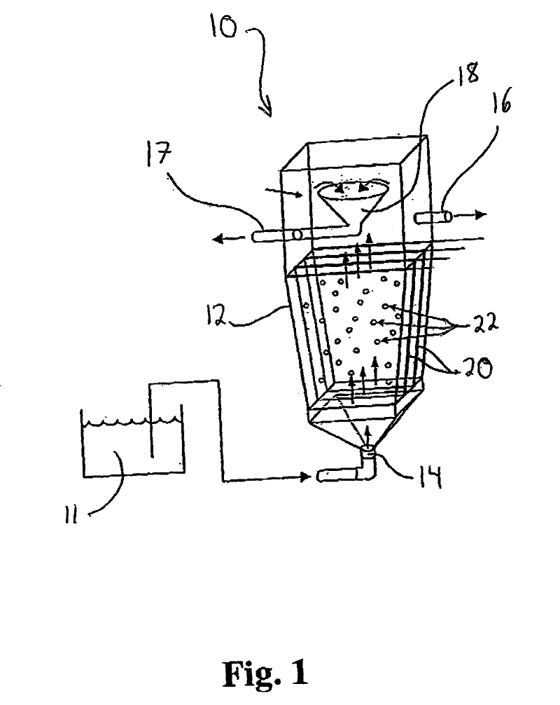

Referring to FIG. 1, according to one embodiment of the present invention, there is provided an electrochemical system comprising an apparatus 10 designed for agglomerating solids suspended, and soluble pollutants entrained, more particularly phosphorus pollutants and derivatives thereof, in an aqueous medium 11. The apparatus 10 comprises a generally frustro-conical container 12 composed of a non-conductible material The container 12 is provided with a lower inlet opening 14 for the supply of the aqueous liquid to be treated, an upper outlet opening underflow line 16 for the outlet of the treated water (purified water), an upper outlet opening overflow line 17 for rejection or recycling of floating matter (flocks), and parallel electrodes 20 allowing optimum fluidization of bed particles. Following the passage of the aqueous medium to be treated between the electrodes 20, the phosphorus products contained in the aqueous medium are flocculated, or agglomerated, to obtain floating phosphorus products. After flocculation, a separation phase occurs at the overflow outlet trap 18 with the floating agglomerated solids falling into the trap 18, and the clarified aqueous medium (purified water) is removed through the upper outlet opening underflow line 16.

The electrodes 20 are connected in series across the container 12 to an alternative current. Metal particles (metal grains) 22 of different sizes and different compositions, as for example steel, aluminum, iron, and magnesium, may be added in the aqueous medium during the treatment. These metal particles 22 dissolved under the current between the electrodes 20 during the treatment of the aqueous liquid, to induce the coagulation and formation of flocks of impurity, such as phosphorus products.

In another embodiment, there is provided an electrochemical system capable of separating the solid matter, or undesirable material, from the liquid phase or water by electroflocculation induced by differential electric application. The electroflocculation may be facilitated or catalyzed by addition of flocculating agents, such as, but not limited to, cationic or anionic compounds. These compounds are electrically charged particles allowing the modulation of the electric potential in the electrochemical system Addition of flocculating agents in the liquid phase during the treatment allows reducing or raising the electroconductivity in the liquid phase, then modulating the rate of flocculation.

One embodiment of the invention is to provide a method that can be automatically operated without monitoring directly by a person.

According to one embodiment of the invention, there is provided a method allowing rigorous management of aqueous waste and wastewater on industrial and animal production plans. The present method allows also of reducing rejection of toxic quantities in the environment, as for example, but not limited to, nitrogenous residues, amoniac, phosphorous compounds, odors, volatile gases, and several chemical or biological contaminants found in the production plans. Moreover, most of the solid matter recovered from the aqueous waste or wastewater could be recycled into useful and valuable compounds, such as, but not limited to, fertilizers or ground additives.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A liquid manure treatment system comprising at least one of a separation system for separating liquid phase and solid phase of liquid manure or a bioreactor for clarifying separated liquid phase by aeration to obtain clarified aqueous phase, in combination with an electrochemical system inducing at least one of a flocculation, coagulation or disinfection of particles contained into said clarified aqueous phase.

2. The liquid manure treatment system of claim 1, wherein said separation system performs at least one of sifting, riddling, filtration, settling, sedimentation, or pressing.

3. The liquid manure treatment system of claim 1 comprising a draining system continuously or periodically evacuating said liquid manure from an animal production farm and displacing said liquid manure to said separation system.

4. The liquid manure treatment system of claim 1, wherein said electrochemical system comprises a water streaming filter.

5. The liquid manure treatment system of claim 2, wherein said separation is performed with a filter which is a membrane filter, porous hard wall, cloth drum type, or tangential filter.

6. The liquid manure treatment system of claim 1 comprising a derived filter system using fibres obtained from dehydrated solid phase of manure for filtering at least a portion of said clarified aqueous phase before or after treatment by the electrochemical system.

7. The liquid manure treatment system of claim 1 comprising a filter after said separation system or said bioreactor for filtering the clarified aqueous phase to allow elimination of gas from said clarified aqueous phase.

8. The liquid manure treatment system of claim 7, wherein said filter is at least one of a bioreactor or a liquid trickling system.

9. The liquid manure treatment system of claim 7, wherein said elimination of gas is performed by at least one of degradation by micro-organisms or solubilization in said clarified aqueous phase.

10. The liquid manure treatment system of claim 1, wherein said electrochemical system used for flocculation or coagulation and disinfection of particles contained into said clarified water comprises:
at least one conduit for collecting said clear liquid containing contaminants;
at least one electrochemical cell comprising a container in fluid flow connection with said conduit for receiving therein said clarified aqueous phase, said container having at least two substantially parallel electrolytic plates contained therein, said electrolytic plates having a plurality of positive and negative plates, said frustro-conical container comprising an upper outlet underflow line opening for the outlet of purified water, and an upper outlet overflow line opening for rejection of said contaminants; and
a voltage source connected to said positive and negative plates for applying a difference potential therebetween, said difference potential causing said contaminants in reaction with said electrolytic plates to flocculate and to float, said contaminants being separated from said clarified aqueous phase to provide purified water, said contaminants rendered floating being separated from said clear liquid at an overflow outlet trap, the contaminants falling into said trap, and the purified water being removed through said upper outlet opening underflow line.

11. A method for separating liquid phase and solid phase from liquid manure comprising the steps of:
c) passing liquid manure through at least one of a separation system to separate solid phase from liquid phase or through a bioreactor to obtain a clarified aqueous phase; and
d) passing said clarified aqueous phase of step a) through an electrochemical system for inducing flocculation of particles in said clarified aqueous phase of step a) and to obtain purified and disinfected water.

12. The method of claim 11, wherein said purified and disinfected water is returned to nature or recycling at least a part in an animal production plan or liquid manure treatment system.

13. The method of claim 11, wherein said separation system performs at least one of sifting, riddling, filtration, settling, sedimentation, or pressing.

14. The method of claim 11, wherein said animal production plan is for production of farm animals.

15. The method of claim 14, wherein said farm animal is for production of porcine, bovine, equine, ovine, caprine, or bird.

16. The method of claim 11, wherein said solid phase is recovered as a fertilizer or a ground additive.

17. The method of claim 11, wherein said separation is performed with a membrane filter, porous hard wall, cloth drum type, or tangential filtration.

18. The method of claim 11, wherein said electrochemical system used for removing contaminants from said clarified aqueous phase comprises:
at least one conduit for collecting said clarified aqueous phase containing contaminants;
at least one electrochemical cell comprising a container in fluid flow connection with said conduit for receiving therein said clarified aqueous phase, said container having at least two substantially parallel electrolytic plates contained therein said electrolytic plates having a plurality of positive and negative plates, said frustro-conical container comprising an upper outlet underflow line opening for the outlet of purified water, and an upper outlet overflow line opening for rejection of said contaminants; and
a voltage source connected to said positive and negative plates for applying a difference potential there between, said difference potential causing said contaminants in reaction with said electrolytic plates to flocculate and to float, said contaminants being separated from said clarified aqueous phase to provide purified and disinfected water, said contaminants rendered floating being separated from said clarified aqueous phase at an overflow outlet trap, the contaminants falling into said trap, and the purified and disinfected water being removed through said upper outlet opening underflow line.

19. The method of claim 11, wherein at least one flocculating agent is added to said separation system or electrochemical system with said liquid manure to precipitate phosphorus and nitrogen compounds.

20. The method of claim 19, wherein said flocculating agent is selected from the group of metal particle, cationic compound, anionic compound, iron salt, aluminum salt, magnesium salt, ferrous chloride, ferrous sulfate, ferric chloride, ferric sulfate, chlorinated ferric sulfate, basic aluminum sulfate, chlorinated basic aluminum sulfate, magnesium chloride, and magnesium sulfate.

21. The method of claim 11 comprising recycling fibres obtained from dehydrated solid phase of manure to form a derived filter for filtering at least a portion of said clarified aqueous phase before or after treatment with the electrochemical system.

22. The method of claim 12 comprising a filter after said separation system or said bioreactor for filtering the clarified aqueous phase to allow elimination of gas from said clarified aqueous phase.

23. The liquid method of claim 22, wherein said filter is at least one of a bioreactor or a liquid trickling system.

24. The liquid method of claim 22, wherein said elimination of gas is performed by at least one of degradation by micro-organisms or solubilization in said clarified aqueous phase.
